(19) United States
(12) Patent Application Publication
(10) Pub. No.: US 2003/0084857 A1
(43) Pub. Date: May 8, 2003

(54) Horse jump system and jump cup assembly apparatus and system

(76) Inventor: Philippe Gavet, Davie, FL (US)

Correspondence Address: David P. Lhota, Stearns Weaver Miller, Suite 1900, 200 East Broward Boulevard, Fort Lauderdale, FL, 33301, US

(21) Appl. No.: 10/259,229

(22) Filed: Sep. 27, 2002

Related U.S. Application Data
(60) Provisional application No. 60/325,443, filed on Sep. 27, 2001.

(51) Int. Cl. A01K 15/02

(52) U.S. Cl. 119/705

(57) ABSTRACT

A horse jump system and jump cup assembly defined by rotatable and releasable jump cups, wherein the system includes a pair of opposing posts having key hole tracks vertically disposed, at least one pair of rotatable jump cup assemblies for mounting to the pair of key hole tracks and at least one pole removably positionable in said jump cups. The jump cup assembly includes a jump cup support mount or coupling that is adapted for removably mounting to the key hole tracks and jump cup adapted for releasably and rotatably mounting to the coupling wherein the jump cup support coupling and jump cup have cooperating interlocking structure, namely an open-ended arcuate channel and corresponding tab that forms a snap fit with the channel. The jump cup is dislodged from the coupling when urged by a predetermined force having vertical and, or horizontal components.

### CROSS REFERENCE TO RELATED APPLICATIONS

This application claims the benefit of U.S. provisional patent application Serial No. 60/325,443, filed Sep. 27, 2001.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to horse jumps, and more particularly, to a horse jump system having a rotatable and releasable jump cup assembly, wherein the jump cup assembly is pivotally attachable to a vertical track, holds one end of a jump pole extending between the tracks and releases upon a predetermined force having vertical, horizontal and/or angular components for reduced risk of rider injury.

2. Description of the Background Art

Horse jumps are well known in the art and comprise opposing vertically disposed posts 2, a pole bridging the posts 2 and opposing jump cup assemblies rigidly and releasably attached to the posts 2 for holding opposing ends of the pole. With reference to FIG. 1, jump cup assemblies known in the art comprise a jump cup mount 3 that is rigidly mounted to the post 2 and has a vertically disposed slot with an open bottom end for receiving and releasing a jump cup 4 when urged by a vertical force. Conventional jump cup mounts are suppose to release from the posts when a horse misses the jump in a manner that does not immediately knock the pole out of the jump cups. However, they do not always release and can become locked in the posts 2 when impacted with a force having a horizontal component. Horizontal forces can lock a jump cup mount 3 in a post 2 because conventional jump cup mounts 3 do not pivot or rotate when experiencing horizontal forces. Rather, they require a direct downward force or a force that is predominantly downward to dislodge the jump cup from its mount 3. In addition, conventional jump cup assemblies are unnecessarily thick such that they extend outward from the post a distance that increases the potential cantilever forces it can experience. Moreover, conventional jump cup assemblies have a design that may be positioned upside down unbeknownst to the installer. These design characteristics increase the risk of injury to the rider and horse and damage to the jump cup assembly and/or jump, which increases the cost for riding and operating jumps. Accordingly, a horse jump system and jump cup assembly that releases across a wider bandwidth of angles so as to reduce the risk of injury to a rider and horse and damage to the jump and jump cup would be well received. The instant invention addresses this need by providing a jump system and jump cup assembly that rotates and releases more easily when realizing forces from a variety of angles.

### BRIEF SUMMARY OF THE INVENTION

In light of the foregoing, the instant invention comprises a horse jump system and jump cup assembly having a unique design that more efficiently and under a wider bandwidth of angular forces releases the jump cup assembly from the jump. The horse jump system comprises a pair of opposing posts having key hole tracks vertically disposed, at least one pair of rotatable jump cup assemblies for mounting to the pair of key hole tracks and at least one pole removably positionable in said jump cups. The keyhole tracks and pole generally comprise components known in the art, except with respect to modifications that accommodate the jump cup assemblies. The jump cup assembly comprises a jump cup support mount or coupling and jump cup adapted for mounting to the coupling. The jump cup support coupling and jump cup have cooperating interlocking structure, namely an open-ended arcuate channel and corresponding tab that forms a snap fit with the channel. In the preferred embodiment, the jump cup support coupling comprises a base, interlocking tab projecting from the base and key track mounting post projecting from the base. The post is terminated by a knob, which has a larger cross sectional area then the post. The jump cup generally comprises a substantially flat header having an interlocking channel and a crescent shaped flange or ledge. The ledge projects directly outward from the header. The jump cup may also comprise at least one support brace. The jump cup interlocking tab mates with the interlocking channel such that the jump cup suspends from the support coupling when assembled. The interlocking tab is notched for biasing inward when mating with the channel and breaking free therefrom. The posts comprise a track having a plurality of keyhole apertures on at least one side. The jump cup support coupling is attached to the keyhole track by inserting the coupling post and knob through the keyhole and urging the post downward into the keyhole slot. A jump pole is installed by setting each end in a corresponding jump cup such that the pole is level.

The jump cup assembly is designed to release the jump cup when vertical, horizontal and/or angular forces having horizontal and vertical components are realized by the jump cup. The jump cup is designed to at least partially rotate and release from the support coupling when impacted with sufficient force. The size of the interlocking tab relative to the interlocking channel dictates the amount of force required to dislodge the tab. The jump cup pivots to avoid locking while the support coupling remains attached to the track when the jump cup is dislodged. The jump cup's ability to pivot prevents the jump cup from locking and breaking.

In accordance with the foregoing, the instant invention will now be described with particular reference to the accompanying drawings.

### BRIEF DESCRIPTION OF THE SEVERAL VIEWS OF THE DRAWINGS

FIG. 1 is a perspective exploded view of the jump cup assembly known in the prior art.

FIG. 2 is a perspective exploded view of the preferred embodiment of the jump cup assembly of the instant invention illustrating the jump cup mounting coupling and jump cup.

FIG. 3 is an elevational view of the preferred embodiment of the jump cup system of the instant invention.

FIG. 4 is a front elevational view of the preferred embodiment of the jump cup assembly of the instant invention illustrating the jump cup mounting coupling and jump cup in mating engagement.

FIG. 5 is a rear elevational view of the preferred embodiment of the jump cup assembly of the instant invention, illustrating the jump cup detached from the jump cup mounting coupling.

FIG. 6 is a front elevational view of the preferred embodiment of the jump cup assembly of the instant invention illustrating the jump cup detached from the jump cup mounting coupling.

FIG. 7 is a side elevational view of the preferred embodiment of the jump cup assembly of the instant invention illustrating the jump cup detached from the jump cup mounting coupling.

FIG. 8 is a front perspective view of the preferred embodiment of the key hole track tower of the instant invention.

FIG. 9 is a cross sectional view of the jump cup assembly mounted to a key hole track tower in accordance with the preferred embodiment of the instant invention.

FIG. 10 is a front elevational view of an alternative embodiment of the jump cup assembly of the instant invention illustrating the jump cup support coupling and jump cup in mating engagement wherein the support coupling defines the channel, or female end, and the jump cup defines the interlocking tab, or male end.

FIG. 11 is a front elevational view of the preferred jump cup support coupling of the instant invention.

FIG. 12 is a side elevational view of an alternative jump cup support coupling of the instant invention showing a base that hangs over a portion of the interlocking tab.

FIG. 13 is a front elevational view of alternative embodiment of the jump cup assembly of the instant invention illustrating an invertible jump cup that can be used for circular poles in a first orientation and for poles having at least one flat surface in a second orientation.

### DETAILED DESCRIPTION OF THE INVENTION

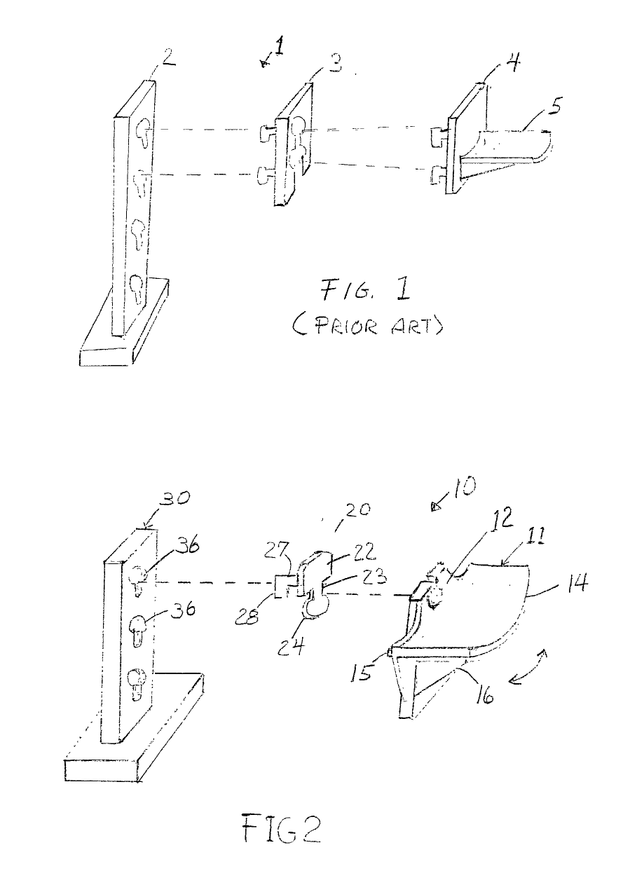

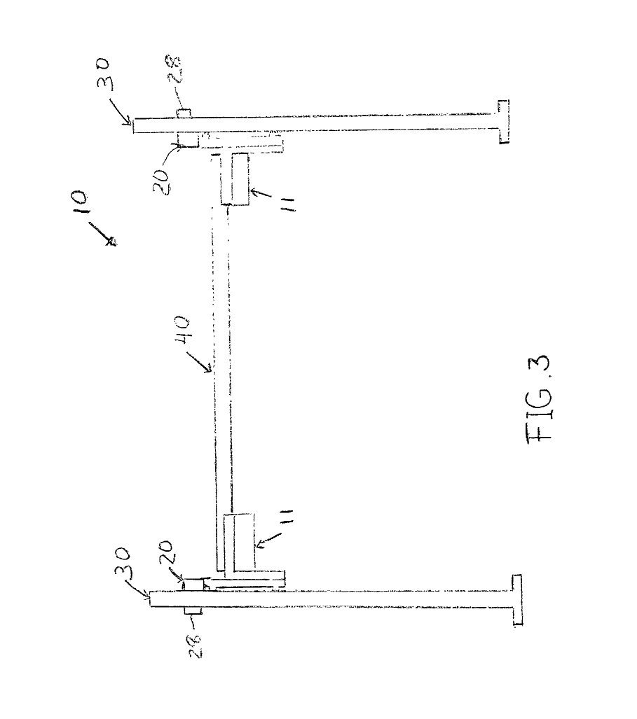

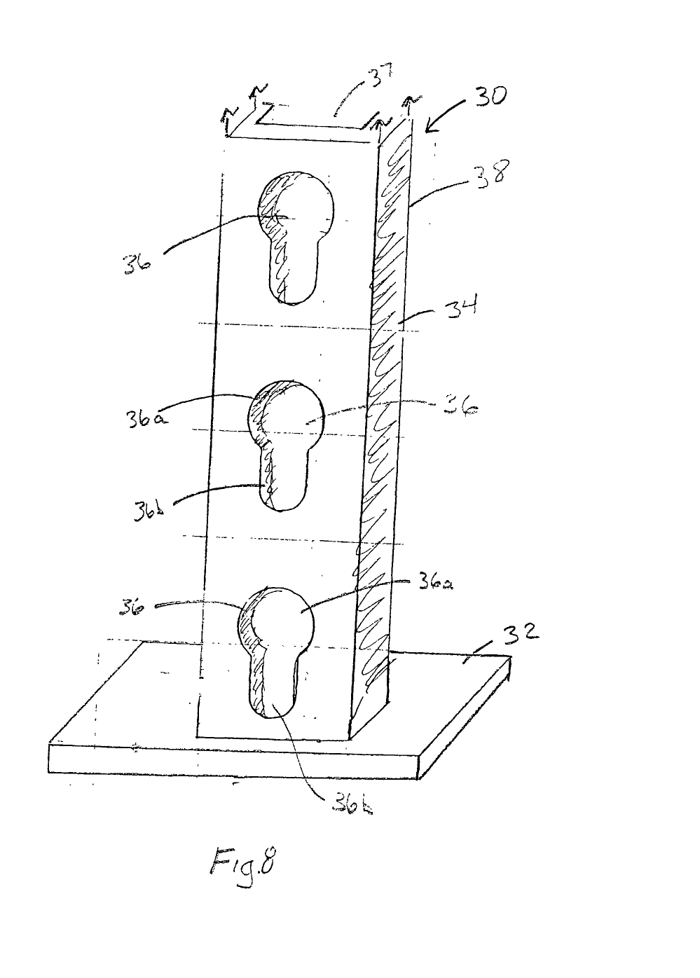

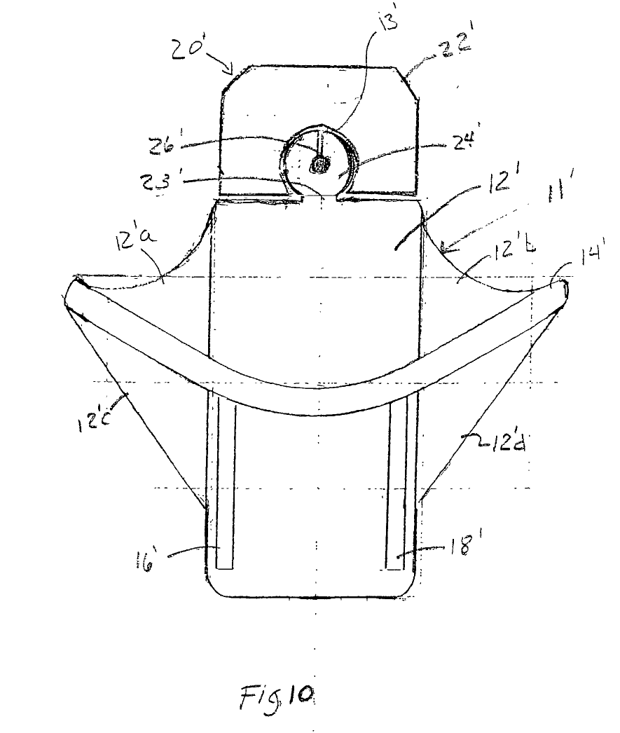

With reference to the drawings, FIGS. 2-13 depict the preferred and alternative embodiments of the instant invention, which is generally referenced by numeric character 10 or as a jump cup assembly or horse jump system. With reference to FIGS. 2-7, the preferred embodiment of the instant invention 10 comprises a jump cup assembly 11, 20 defined by a jump cup 11 and jump cup support coupling 20 having a unique design for releasing the jump cup 11 from the jump system with less resistance than previously known. The horse jump system comprises a pair of opposing and vertically disposed key hole tracks 30, as shown in FIGS. 8 and 9, at least one pair of rotatable jump cup assemblies 11, 20 for mounting to the pair of key hole tracks 30 and at least one pole removably positionable in said jump cups 11. The key hole tracks 30 and pole (not shown) generally comprise components known in the art, except with respect to modifications that accommodate the jump cup assemblies 11, 20, which in combination define a new, useful and non-obvious system.

Referring to FIGS. 2-7, the jump cup assembly 11, 20 comprises a jump cup 11 and jump cup support coupling 20. The jump cup 11 generally comprises a substantially flat base 12 defining an interlocking channel 13 at its upper end, a crescent shaped flange 14 approximately perpendicular to and projecting outward from the base 12 and a pair of support braces 16, 18. The interlocking channel 13 defines an opening 19 for receiving the corresponding interlocking tab 24 that depends from the support coupling 20. The amount of force required to dislodge the interlocking tab 24 is dictated and controlled by the size of the interlocking channel 13 and opening 19 defined by the channel 13. The narrower the opening 19 to the interlocking channel 13 the more force that is required to dislodge the jump cup 11 from the support coupling's interlocking tab 24, as further explained below. The opening 19 may be adjusted to accommodate local standards and/or rules.

The jump cup 11 is preferably a single composite piece but may comprise multiple molded pieces. For instance, the base 12 may include a back panel 12e joined to the rear of the base 12, as shown in FIG. 7. The base 12 may include a plurality of extensions or wings for added structural integrity and support for the pole, such as an upper left wing 12a, upper right wing 12b, lower left wing 12c and lower right wing 12d. The support braces 16, 18 also strengthen the jump cup 11 by bracing the crescent shaped flange 14. With reference to FIG. 7, the rear surface of the base 12 may include a plurality of projecting retention tabs 15, preferably one near each corner, to limit or control the amount of lateral or rotational movement of the jump cup support coupling 20 when the jump cup 11 is hit or otherwise caused to pivot.

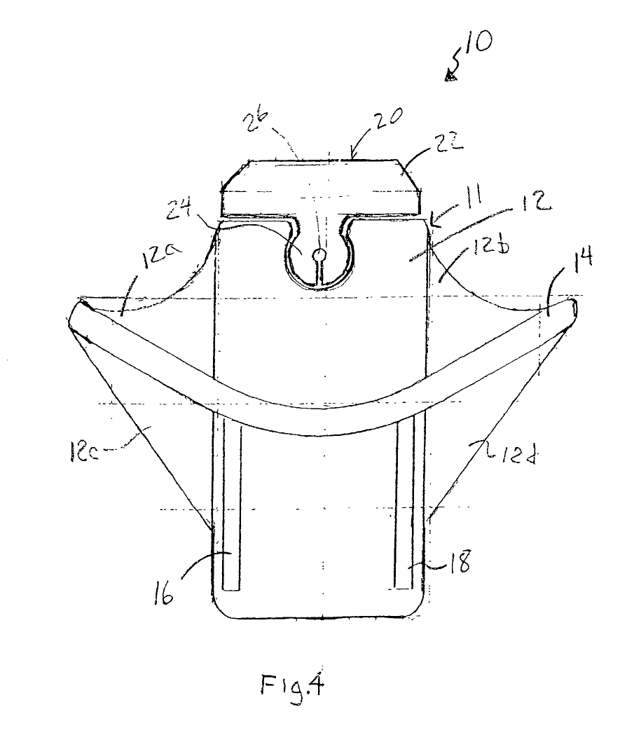

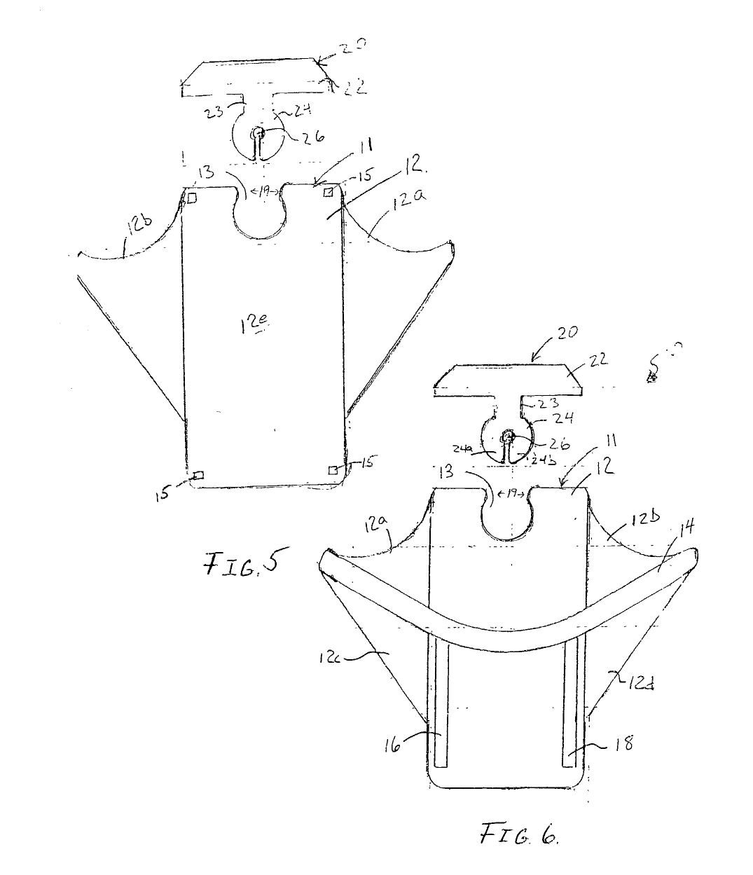

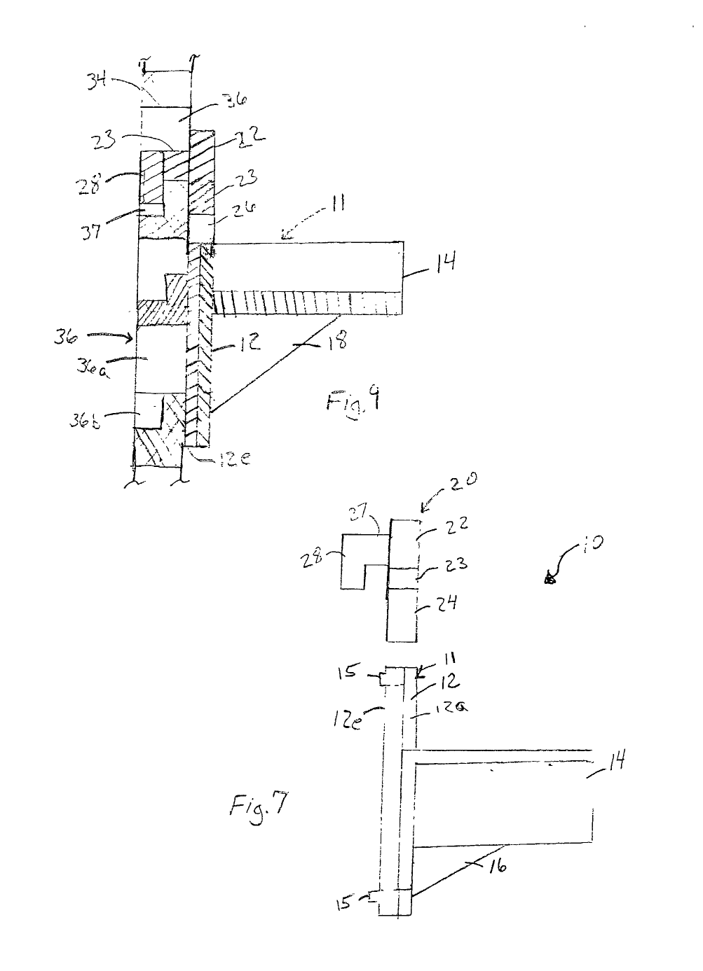

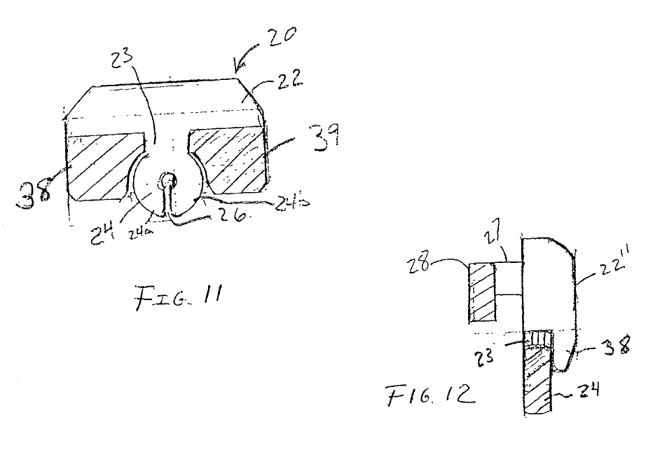

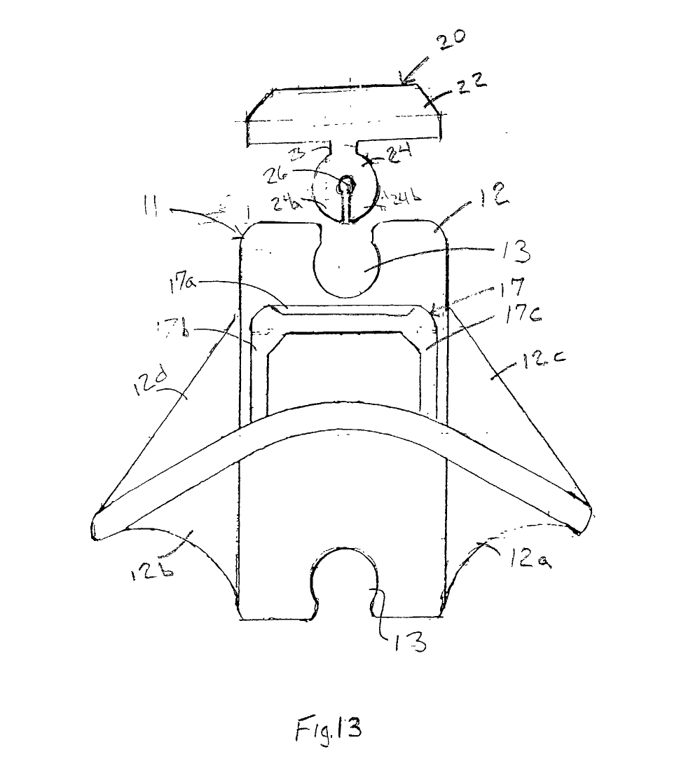

With reference to FIGS. 4 to 13, the jump cup support coupling 20 comprises a header 22, interlocking tab 24 having an upper narrowed section 23 bridging the lower end of the header 22 and the upper end of the tab 24, and key track mounting post 27 and knob 28 assembly projecting outward from the rear face of the header 22. The header 22 comprises a width and thickness that is comparable to that of the support cup base 12 and which provides adequate support for the interlocking tab 24 and mounting post assembly 27, 28, as shown in FIGS. 2-7 and 11. In an alternative embodiment, the header 22 may partially extend below the front surface of the interlocking tab 23, 24 to define lips or guards 38, 39, that prevent improper set-up and unwanted dislodgement, as shown in FIGS. 11 and 12.

The interlocking tab 24 depends downward from the header 22 and has a narrowed bridge section 23 joining it to the header 22. The interlocking tab 24 mates with the jump cup interlocking channel 13 such that the jump cup 11 suspends from the tab 24 and support coupling 20 when assembled, as shown in FIG. 4. The diameter or width of the interlocking tab 24 is larger than the width of the jump cup channel opening 19. The interlocking tab 24 defines a notch or mounting groove 26 from its center outward along a predetermined radial line, and preferably at approximately two hundred and seventy degrees (270°) for biasing when mating with or departing from the channel 13. The groove 26 divides the lower hemisphere or half of the tab 24 into two biasing members, a left side 24a and a right side 24b. As the width of the tab 24 is larger than the opening 19, the amount of force required to dislodge the tab 24 is directly related to the tab width to opening 13 width ratio, wherein the force required to dislodge the jump cup 11 increases and decreases with the ratio. When the tab 24 is inserted into or dislodged from the channel 13, the left side and right side biasing members 24a, 24b are urged closer together thus narrowing the tab 24 and allowing it to pass through the channel 19.

The interlocking coupling 20 includes a mounting post 27 terminated by a knob 28, a portion of which depends below the post 27 to form a recession. The mounting post 27 projects outward from the rear surface of the header 22 and is substantially perpendicular thereto. The post 27 may comprise an integral component of the header 22 or an attached component. The knob 28 is joined as an integral piece or attached to the outside end of the post 27. The recession defined between the knob 28 and header 22 reside within the key hole apertures of the posts 30 being used when the support coupling is mounted to a post. The knob 28 also prevents the support coupling 20 from being pulled directly outward.

The key hole tracks 30 comprise towers or posts having a base 32, side walls 34, a rear wall 38 and a plurality of key hole apertures 36. The apertures 36 are preferably defined in the front wall of the track 30. The apertures 36 comprise a two tiered opening wherein the upper tier 36a is substantially circular and larger than the lower tier 36b. The upper tier 36a should be large enough to receive the knob end 28 of the interlocking coupling 20. The width of the lower tier 36b is smaller than the width or diameter of the knob 28. Accordingly, the knob 28 can only be removed through the upper tier 36a. A jump cup support coupling 20 is mounted to a post 30 by inserting the coupling post 27 and knob 28 through the key hole 36 and urging the post 27 downward into the key hole's lower tier 36b. In the system of the invention 10, at least two posts 30 are positioned a predetermined distance apart corresponding to the length of the pole and support couplings 20 are mounted to the posts 30 at corresponding heights that result in a level jump pole. A jump pole is installed by setting each end in a corresponding jump cup 11 such that the pole is level.

With reference to FIG. 10, in an alternative embodiment the invention comprises a modified jump cup 11′ and support coupling 20′. The jump cup 11′ has a base 12′ which defines a tab 24′ at its upper end, crescent shaped flange 14′ and support braces 16′, 18′. The tab 24′ defines a groove 26′ at approximately ninety degrees (90°) and a bridge 23′. The corresponding alternative support coupling 20′ comprises a header 22′ defining an interlocking channel 13′ at its lower end and post and knob assembly. The support coupling 22′ and jump cup 11′ are as described with reference to the preferred embodiment except that the support coupling 20′ defines the channel 13′ and the jump cup 11′ defines the interlocking tab 24′.

In another alternative embodiment, the jump cup 11 defines a second channel 13 and opening 19 at the lower end of the base 12 and includes a second flange 17. The second channel 13 and opening 19 are substantially the same as the first channel 13 and opening 19. Unlike the crescent shaped flange 14, the second flange 17 defines an upper flat surface 17a that is slightly recessed and two opposing side walls 17b and 17c. The second flange 17 accommodates poles having a flat edge while the crescent shaped flange 14 accommodates round poles.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A jump cup assembly for supporting a horse jumping pole, said assembly comprising:
a jump cup comprising a header and a ledge projecting outward from said header; and
jump cup mounting coupling, said coupling comprising a base and a securing tab projecting outward from said base; and
an interlocking means for releasably and rotatably joining said jump cup and said jump cup mounting coupling, said interlocking means comprising a first interlocking component defined by said header and a second corresponding interlocking component defined by said jump cup mounting coupling.

2. An assembly as recited in claim 1, wherein said first interlocking component comprises:
an interlocking channel defined by said header for releasably and rotatably supporting said second corresponding interlocking component.

3. An assembly as recited in claim 2, wherein said second interlocking component comprises:
an interlocking tab projecting from said coupling base, said interlocking channel and interlocking tab having dimensions that releasably and rotatably join said interlocking tab and channel wherein said interlocking tab is dislodgable from said interlocking channel under a predetermined force.

4. An assembly as recited in claim 1, wherein said securing tab comprises a shaft and a distal end that extends beyond the perimeter of said post.

5. An assembly as recited in claim 1, wherein said assembly comprises at least two of said jump cups and at least one of said mounting couplings per jump cup.

6. An assembly as recited in claim 4, further comprising:
two posts, each of said posts comprising a plurality of key holes, said tab adapted for releasably interlocking with said key holes; and
a horse jumping pole that bridges said posts and is supported on opposite ends on said ledges of said jump cups.

7. An assembly as recited in claim 1, wherein said first interlocking component comprises:
an interlocking channel defined by said coupling base for releasably and rotatably supporting said second corresponding interlocking component.

8. An assembly as recited in claim 7, wherein said second interlocking component comprises:
an interlocking tab projecting from said header, said interlocking channel and interlocking tab having dimensions that releasably and rotatably join said interlocking tab and channel wherein said interlocking tab is dislodgable from said interlocking channel under a predetermined force.

9. An assembly as recited in claim 1, further comprising:
at least one retention tab projecting back from said cup for controlling the amount of rotational movement of said cup.

10. A jump cup assembly for supporting a horse jumping pole, said assembly comprising:
a jump cup comprising a header and a ledge projecting outward from said header; and
jump cup mounting coupling, said coupling comprising a base and a securing tab projecting outward from said base; and
an interlocking means for releasably and rotatably joining said jump cup and said jump cup mounting coupling, said interlocking means comprising an interlocking channel defined by said header and an interlocking tab projecting from said mounting coupling base, said interlocking channel and interlocking tab having dimensions that releasably and rotatably join said interlocking tab and channel wherein said interlocking tab is dislodgable from said interlocking channel under a predetermined force.

11. An assembly as recited in claim 10, wherein said securing tab comprises a shaft and a distal end that extends beyond the perimeter of said post.

12. An assembly as recited in claim 11, wherein said assembly comprises at least two of said jump cups and at least one of said mounting couplings per jump cup.

13. An assembly as recited in claim 12, further comprising:
two posts, each of said posts comprising a plurality of key holes, said tab adapted for releasably interlocking with said key holes; and
a horse jumping pole that bridges said posts and is supported on opposite ends on said ledges of said jump cups.

14. An assembly as recited in claim 10, further comprising:
at least one retention tab projecting back from said cup for controlling the amount of rotational movement of said cup.

15. A jump cup system, said system comprising:
a pair of jump cups, each jump cup comprising a header and a ledge projecting outward from said header; and
a pair of jump cup mounting couplings, each coupling comprising a base and a securing tab projecting outward from said base;
an interlocking means for releasably and rotatably joining said jump cup and said jump cup mounting coupling, said interlocking means comprising a first interlocking component defined by said header and a second corresponding interlocking component defined by said jump cup mounting coupling;
two posts, each of said posts comprising a plurality of key holes, said tab adapted for releasably interlocking with said key holes; and
a horse jumping pole that bridges said posts and is supported on opposite ends on said ledges of said jump cups.

16. An assembly as recited in claim 15, wherein said securing tab comprises a shaft and a distal end that extends beyond the perimeter of said post.

17. An assembly as recited in claim 15, wherein said first interlocking component comprises:
an interlocking channel defined by said header for releasably and rotatably supporting said second corresponding interlocking component.

18. An assembly as recited in claim 17, wherein said second interlocking component comprises:
an interlocking tab projecting from said coupling base, said interlocking channel and interlocking tab having dimensions that releasably and rotatably join said interlocking tab and channel wherein said interlocking tab is dislodgable from said interlocking channel under a predetermined force.

19. An assembly as recited in claim 15, wherein said first interlocking component comprises:
an interlocking channel defined by said coupling base for releasably and rotatably supporting said second corresponding interlocking component.

20. An assembly as recited in claim 19, wherein said second interlocking component comprises:
an interlocking tab projecting from said header, said interlocking channel and interlocking tab having dimensions that releasably and rotatably join said interlocking tab and channel wherein said interlocking tab is dislodgable from said interlocking channel under a predetermined force.
